(19) United States
(12) Patent Application Publication
(10) Pub. No.: US 2008/0109266 A1
(43) Pub. Date: May 8, 2008

(54) Method, Computer Program Product and Milking Station for Initiating an Action to be Performed with Respect to a Milking Animal

(75) Inventors: Anders Björk, Norsborg (SE); Susanne Granz, Grodinge (SE)

Correspondence Address: BIRCH STEWART KOLASCH & BIRCH, PO BOX 747, FALLS CHURCH, VA, 22040-0747, US

(73) Assignee: DELAVAL HOLDING AB, TUMBA (SE)

(21) Appl. No.: 10/556,347

(22) PCT Filed: May 12, 2004
(86) PCT No.: PCT/SE04/00727

§ 371 Date: Feb. 23, 2007

(30) Foreign Application Priority Data
May 14, 2003 (SE) 0301393-5

(51) Int. Cl. G06Q 10/00; A01J 5/017

(52) U.S. Cl. 705/7; 119/14.08

(57) ABSTRACT

A method includes the steps of recording milk yields (MY?1#191, MY?2#191, MY?N#191) from milkings of an udder quarter or udder of a milking animal; recording the times (t₁, t₂, . . . , t_{N}) of the milkings; calculating milk secretion rates (MSR₁, MSR₂, . . . , MSR_{N}) for said udder quarter or udder based on the milk yields and times; fitting a time dependent function (F(t)) to the calculated secretion rates, said time dependent function comprising one portion, which increases with time, and one portion, which decreases with time; estimating an expected milk secretion rate (EMSR_{t1+N}) for said udder quarter or udder at a time (t_{N+1}) following the last milking based on said function (F(t)); determining an expected milk yield (EMY_{tN+1}) for said udder quarter or udder at said time based on the expected secretion rate and, at said time, the time period lapsed since last milking; and initiating an action to be performed with respect to said animal depending on said expected milk yield.

### TECHNICAL FIELD OF THE INVENTION

The present invention relates generally to dairy farming and to supervision and control of a herd of milking animals and their milk production.

### DESCRIPTION OF RELATED ART AND BACKGROUND OF THE INVENTION

In an automated and highly complex system such as an automated milking system, where no one is present during milking, it is important to use alternative means to monitor the milking animals. These include to continuously monitoring the milking performance, the milking process, the milking interval, and the achievable milk production of every individual milking animal.

The milking performances are monitored to notice any deviation from previous performances. A decrease in production, in a degree that deviates from the normal variation of the individual animal, may be an indication that the animal is unhealthy. The milking processes are monitored to identify individual animals that repeatedly render unsuccessful milkings due to e.g. incomplete milking or teat cup kick-offs. Animals that repeatedly experience unsuccessful milkings will yield less milk and are more prone to developing udder deceases.

The milking intervals are monitored to identify animals that repeatedly tend to get too long milking intervals. The accumulated yield normally increases with more frequent milking. Thus, extended milking intervals of high producing animals should be avoided. Sudden extended milking intervals of an animal that uses to visit the milking station regularly may also indicate illness. The achievable milk production is monitored to find animals that produce below their potential. Such animals are a potential loss of milk income.

The monitoring is based on collection and comparison of data. The data are collected to build up a model for each of the animals, of what is considered to be normal in terms of milk yield, milk characteristics such as e.g. milk conductivity, and animal behavior. Collection of data is carried out continuously during operation. Accumulated historic data of milk yield are analyzed in a computer model to estimate expected future milk yield data. The expected yield for a specific milking animal is based on the normal level of milk secretion rate (milk production in grams per hour) for that animal and time lapsed since last milking of the milking animal. The actual milk yield is in the model compared with the expected yield. If deviations are found, which are considered to be larger than normal variations in the yields, this will be indicated to the farmer, e.g. by being highlighted on a computer screen. The accuracy will depend on the amount of collected data and the model used.

### SUMMARY OF THE INVENTION

Typically, the expected milk secretion rate is determined as a constant value, as a mean value or as a rolling mean value from the historic data of actual milk secretion rates as determined from milk yields and milking intervals.

However, such methods of estimating expected milk secretion rate are rather static, and do not take into account an increased or decreased milk secretion rate over the lactation period. Particularly, the methods fail to take into account the dependence of the milk secretion rate on number of days in lactation. Any adaptation to higher or lower milk secretion rates will be very slow.

A general object of the present invention is to provide a method for initiating an action to be performed with respect to a milking animal depending on a novel method of determining expected milk yield, which lacks the drawbacks and limitations associated with the prior art described above.

A particular object of the invention is to provide such a method, which takes into account the actual lactation curve of the particular milking animal to fastly adapt to an altered milk secretion rate.

It is still a further object of the invention to provide such a method, which is capable of determining expected milk yields not only on a milking animal individual basis, but also on a teat individual basis.

It is still a further object of the invention to provide such a method, which is reliable, flexible, of fairly low cost, and relatively easy to implement.

Yet further objects of the invention are to provide a computer program product, which carries out the above method when the product is run on a computer, and a milking station having the above method implemented.

These objects, among others, are according to the present invention attained by methods, computer program products and milking stations as specified in the appended patent claims.

Further characteristics of the invention, and advantages thereof, will be evident from the following detailed description of preferred embodiments of the present invention given hereinafter and the accompanying FIGS. 1-7, which are given by way of illustration only, and thus are not limitative of the present invention.

In the following detailed description the milk producing animals are cows. However, the invention is not limited to cows, but is applicable to any animals having the capability to produce milk, such as sheep, goats, buffaloes, horses, etc. By the term udder quarter is meant a separate milk production unit of a milking animal, where the milk produced therein is extracted through a single teat. Thus, provided that the animal is e.g. a sheep or a horse, the term udder quarter as used in the description should be exchanged for udder half.

### BRIEF DESCRIPTION OF THE DRAWINGS

FIG. 1 illustrates schematically, in a perspective view, components of a milking station including a process and control device for carrying out the present invention.

FIG. 2 is a schematic diagram of milk yields obtained at milking of an udder quarter of a cow versus time since first milking in a lactation period.

FIG. 3 is a schematic diagram of the milking intervals indicated in FIG. 1 versus time since the first milking in the lactation period.

FIG. 4 is a schematic diagram of (i) milk secretion rate versus time as calculated from milk yields and milking intervals; and of (ii) a time dependent function F(t) fitted to the calculated milk secretion rate.

FIG. 5 is a schematic lactation curve illustrating the milk secretion rate for a single udder quarter of a cow as a function of time during a complete lactation period.

FIG. 6 is a schematic diagram of milk production as a function of time between two consecutive milkings of a single udder quarter of a cow.

FIG. 7 is a schematic diagram of milk secretion rate as a function of time between two consecutive milkings of a single udder quarter of a cow.

### DETAILED DESCRIPTION OF EMBODIMENTS

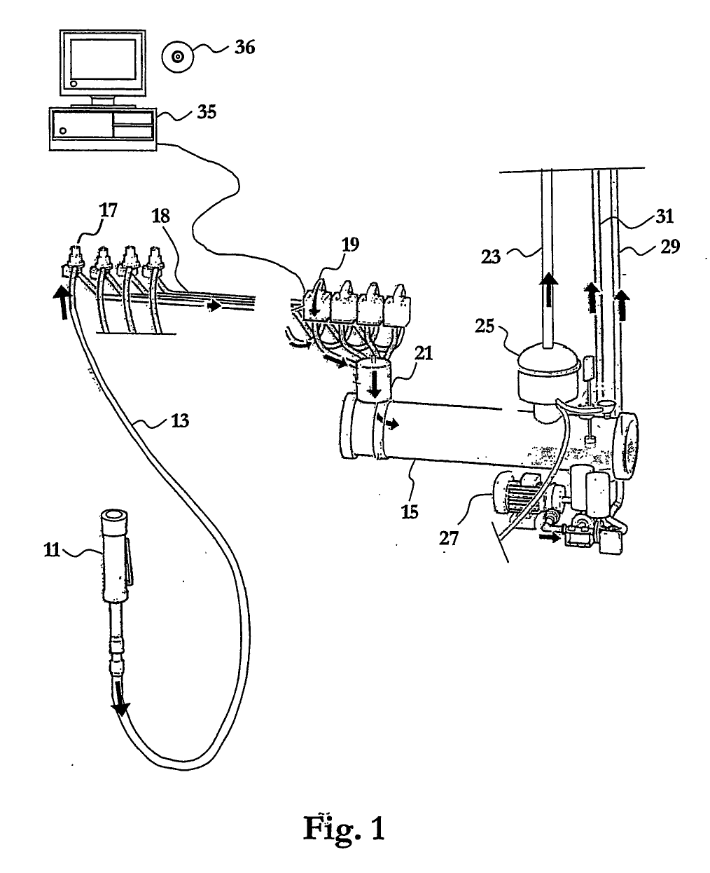

FIG. 1 illustrates some of the main components of an automated milking station for cows wherein the present invention is implemented. The automated milking station comprises four teat cups 11, of which only one is illustrated for sake of simplicity. Each teat cup 11 is connected to a respective milk tube 13, which in turn is connected to an end unit 15 via a respective valve or regulator 17, a respective milk conduit 18, a respective flow meter 19, and a common milk meter 21. The end unit is connected to a vacuum source (not illustrated) via a milk/air separator and a vacuum supply conduit 23.

During milking of the teats of a cow, the teat cups are typically attached to the teats of a cow by a robot arm (not illustrated) and vacuum is supplied to the end unit 15 via the vacuum supply conduit 23 to draw milk from the teats of the cow, through the milk lines 13 and into the end unit 15. The valves or regulators 17 may be used to control the individual vacuum levels in the teat cups 11. The milk yield from each udder quarter of the cow is measured individually by the flow meters 19, wherafter the weight of the milk from the cow is measured by the common milk meter 21. Finally, the milk is collected in the end unit 15 and the air is sucked out through the conduit 23.

Further, the milking station comprises a pump and regulator system 27 for pumping the milk to e.g. a larger milk storage tank (not illustrated) via one 29 of a plurality of milk output lines 29, 31 connected to the end unit. Another milk output line 31 may be used for discarding milk from the milking of a cow, for pumping the milk to another tank (not illustrated), or for pumping the milk to a feed device for feeding calves.

The milking station is advantageously connected to a computer-based process and control device 35, which is responsible for processing and controlling of the automated milking station, and comprises typically a microcomputer, suitable software, and a database including information of each of the cows milked at the milking station, such as e.g. when the respective cow was milked last time, when she was fed last time, her milk production, her health, etc.

A monitoring and managing system of the present invention is preferably implemented as a computer program product stored on a suitable storage medium, e.g. a disc 36. The computer program product is loadable into the memory of the process and control device 35, and comprises software code portions for carrying out the various actions described below when the computer program product is run on the process and control device 35.

The inventive monitoring and managing system comprises six main modules:
Module for recording milk yield and milking time
Module for calculating milk secretion rate
Module for fitting a time-dependent function
Module for estimating expected milk secretion rate
Module for determining expected milk yield
Module for initiating an action

The module for recording milk yield and milking time records milk yields

MY₁, MY₂, . . . , MY_{N}

as obtained during a plurality of milkings of a specific udder quarter of a specific cow. It further records the point of time

t₁, t₂, . . . , t_{N}

of each of the plurality of the milkings. Preferably, the points of time are given as times since the beginning of a lactation period for the cow, or as times since the first milking of a cow in a lactation period. Preferably, the times are all within the same lactation period.

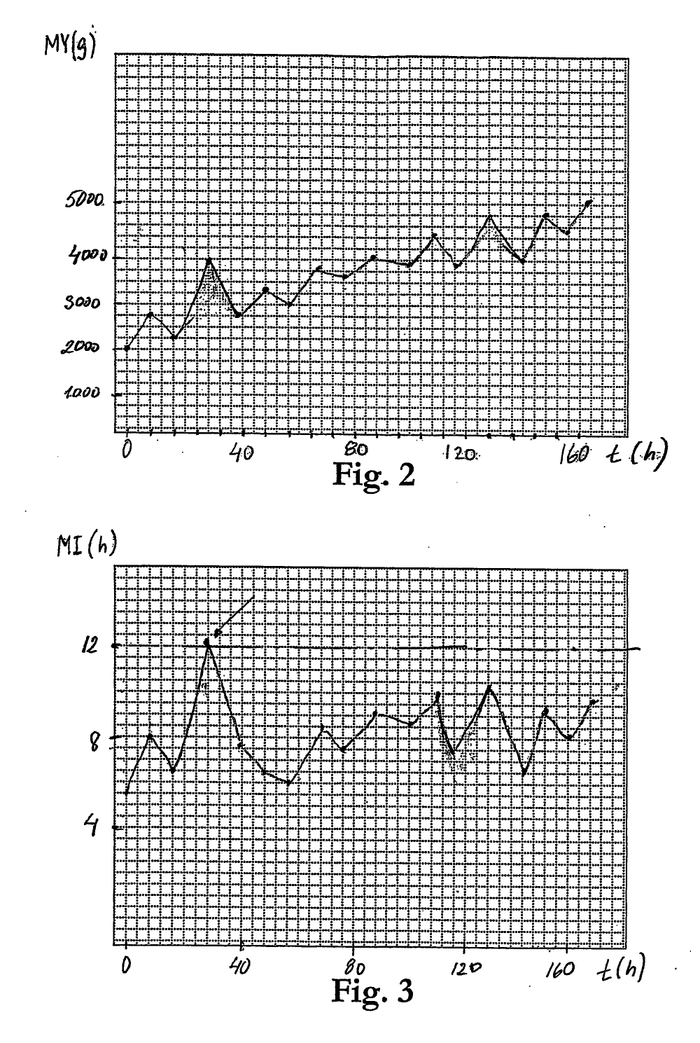

FIG. 2 is a schematic exemplary diagram of milk yields MY as obtained during 18 consecutive milkings of an udder quarter of a cow versus time t of milking and FIG. 3 illustrates the 18 milking interval values MI versus time t of milking. Naturally, there is a close relationship between these two graphs since a long milking interval gives rise to a larger milk yield during the subsequent milking (given a stable milk secretion rate) than a shorter milking interval does. This holds if the milking interval is not too long, e.g. below 12 hours. However, this shall not be mixed with the accumulated milk yield, which is known to increase with shorter milking intervals since the udder quarters are stimulated to produce more milk producing cells and more milk if the cow is milked more frequently.

The module for calculating calculates milk secretion rates

MSR₁, MSR₂, . . . , MSR_{N}

for the specific udder quarter of the specific cow based on the recorded milk yields and times:

MSRᵢ=MYᵢ/MIᵢ=MYᵢ/(tᵢ−tᵢ₋₁), i=1, . . . , N

In FIG. 4 is shown the milk secretion rate (solid line with dots) as a function of time as calculated from milk yields and milking intervals of FIGS. 2-3.

The module for fitting a time-dependent function fits a function F(t) comprising one portion, which increases with time since beginning of lactation, and one portion, which decreases with time since beginning of lactation, to the calculated milk secretion rate as shown in FIG. 4. Thus, a lactation curve is adapted to the existing data.

The time dependent function F(t) is fitted to the calculated milk secretion rate by any kind of technique known in the art, e.g. a non-linear minimum quadratic method.

In FIG. 4 is shown the time dependent function F(t) (dashed line) fitted to the calculated milk secretion rate (solid line with dots).

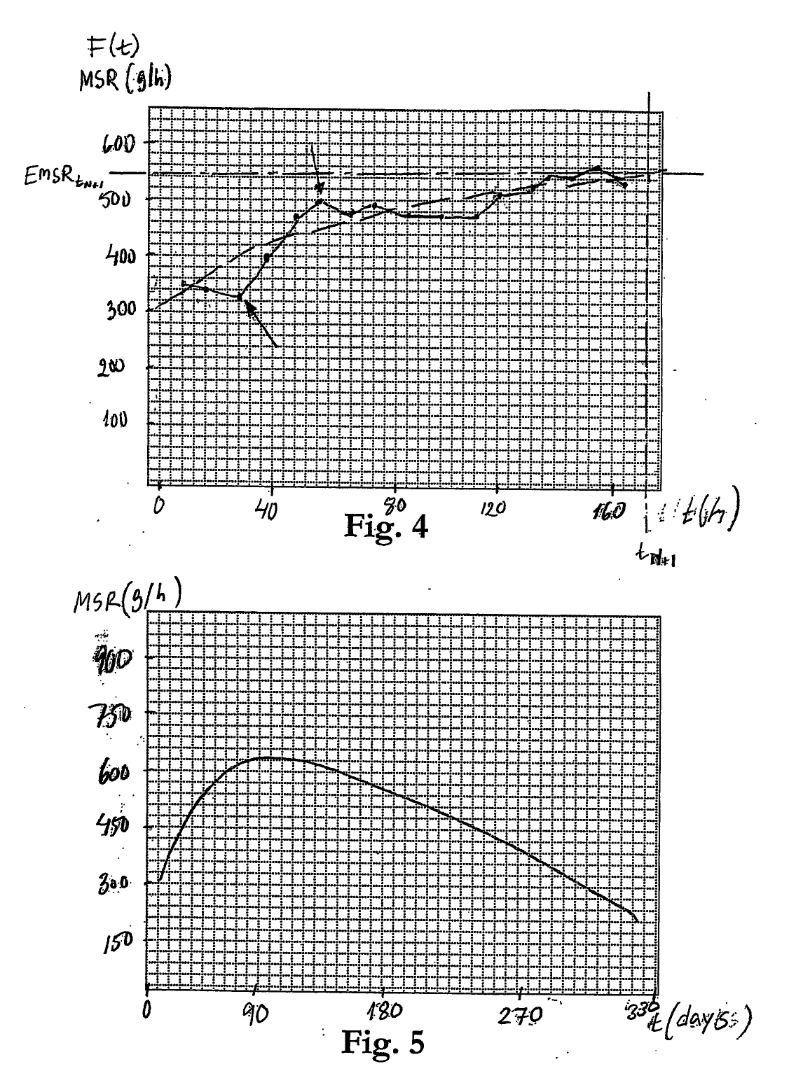

The function is shaped to increase with time for low time values (corresponding to an early phase of a lactation period), to reach a maximum value and to then decrease with time (corresponding to a late phase of the lactation period), in order to be capable of following a typical lactation curve such as the one illustrated in FIG. 5. The milk secretion rate for a single udder quarter of a cow increases steadily in the beginning of each lactation period and reaches after a certain number of weeks a maximum secretion rate value. Then the rate decreases slowly until the cow ultimately becomes dry or is withheld from milking in order to be dried off.

The time dependent function F(t) is preferably given by a polynomial

F(t)=A+Bt+Ct²+ . . .

of at least second order, but may be given in alternatives manners such as by a Taylor polynomial or by

F(t)=A*t^{B}*exp(Ct)

The same general shape of formula should be used for all udder quarters of all cows in the herd, but the constants A, B and C will be different for each cow and even for each udder quarter.

If a value of the calculated milk secretion rate deviates from the time dependent function F(t) with more than a predetermined amount, the value may be considered to be suspicious due to malfunctioning milking equipment, disrupted milking, sudden illness, or may be erroneous due to other reasons. Such value may then be deleted from the calculated milk secretion rate, after which the fitting of the time dependent function to the calculated milk secretion rate is performed once more. By such provision the function F(t) will be closer fitted to the remaining milk secretion rate values, and is thus expected to better reflect the actual rate. In FIG. 4 the two milk secretion rate values identified by the arrows may be considered to be suspicious and is thus disregarded in the fitting process.

The module for estimating expected milk secretion rate estimates an expected milk secretion rate

EMSRₜ_{_{N+1}}

for the specific udder quarter of the specific cow at a time t_{N+1} following the last one of the recorded milkings based on the time dependent function F(t). This is performed by means of referring to a look-up table, possibly followed by an interpolation between two values or by an extrapolation from a value, or by simply calculating the function F(t) for the time t_{N+1}. In FIG. 4 the time t_{N+1} and the estimated expected milk secretion rate EMSRₜ_{_{N+1}} are indicated.

The module for determining expected milk yield determines an expected milk yield EMYₜ_{_{N+1}} for the specific udder quarter of the specific cow at the time t_{N+1} based on (i) the calculated expected milk secretion rate and the time period t_{N+1}−t_{N} lapsed since last milking of that udder quarter.

Provided that the time period t_{N+1}−t_{N} is within a predetermined range, e.g. 6-12 hours, the expected milk yield for the udder quarter may be calculated as

EMYₜ_{_{N+1}}=EMSRₜ_{_{N+1}}*(t_{N+1}−t_{N})

i.e. the calculated expected milk secretion rate multiplied with the time period lapsed since last milking of that udder quarter.

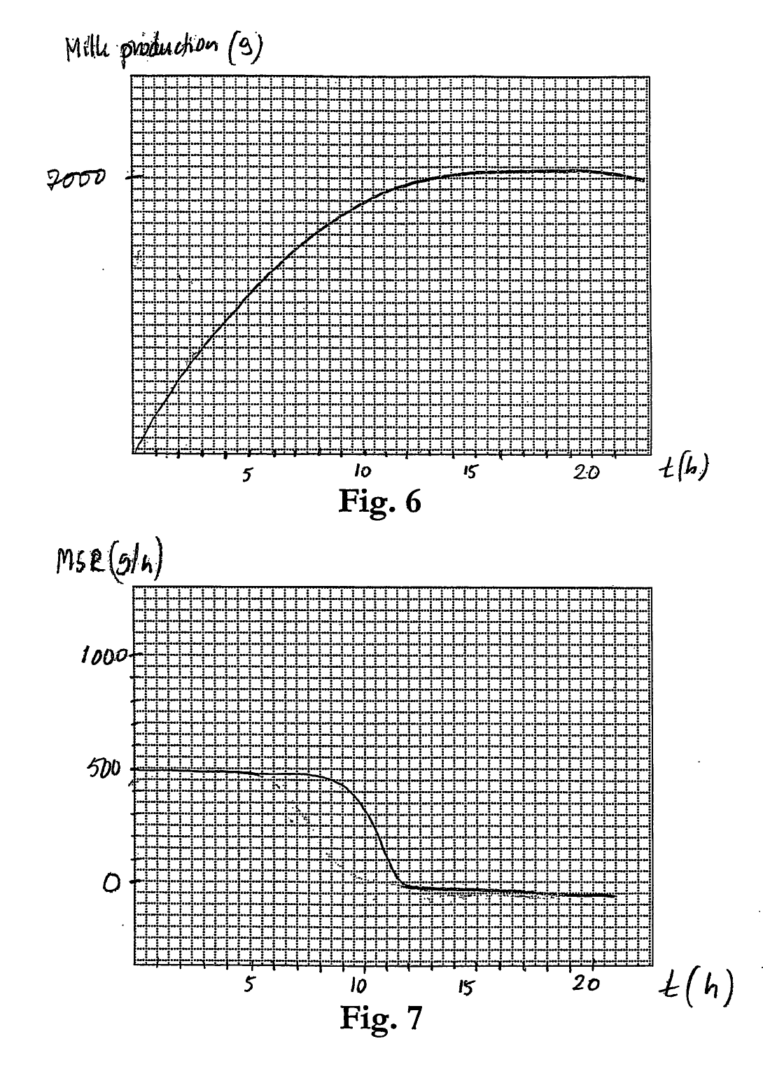

However, the actual milk secretion rate of the specific udder quarter of the specific cow varies with time between two consecutive milkings as is schematically illustrated in FIGS. 6 and 7. FIG. 6 is a schematic exemplary diagram of the actual milk production as a function of the time between two consecutive milkings for an udder quarter of a cow, and FIG. 7 is a schematic exemplary diagram of the actual milk secretion rate as a function of the time between two consecutive milkings for an udder quarter of a cow. For a given udder quarter and time range the time dependent milk production is the time integral of the milk secretion rate. It can be seen that the actual milk secretion rate is highest in the beginning of the period, i.e. directly after having been milked. The rate is then fairly constant (actually slightly decreasing). When the udder quarter starts to get filled, the rate decreases, and if the udder quarter is not milked within a predetermined time, the rate becomes negative, i.e. milk is dissolved.

As the milk secretion rate is measured at the time of milking (by measuring milk yield and time since last milking) in the model, a single milk secretion rate value is obtained at each milking. Nevertheless, by knowledge of the time lapsed since last milking and information as the one illustrated in FIGS. 6-7, whether this is available for the specific udder quarter or for the specific cow through historic data, or only on a general level, e.g. for the breed, age, and/or lactation number of the cow, the expected milk yield for the specific udder quarter may corrected.

A simple model is to simplify the actual milk secretion rate of FIG. 7 by (i) using a single constant value up to a certain time period (e.g. 12 hours), and (ii) then (above 12 hours) assume that the rate is zero. Other, more complicated models can easily be contemplated by the person skilled in the art. For instance, a second order polynomial may be fitted to the actual milk secretion rate.

Generally, the expected milk yield for the specific udder quarter may be determined to be lower than the calculated expected milk secretion rate multiplied with the time period lapsed since last milking of the udder quarter provided that the time period is longer than a certain period of time.

Further, the expected milk yield may be determined to be higher than the calculated expected milk secretion rate multiplied with the time period lapsed since last milking provided that the calculated milk secretion rate at the time of the last milking of the udder quarter was considerably lower than the time dependent function F(t) at that time. This may indicate that the milking was not complete, and that the expected yield should accordingly be increased by the difference

F(tₙ)−MSRₙ

corresponding to the milk left in the udder quarter since last milking.

Such condition may also affect the above-identified certain period of time since the udder quarter is more quickly filled if milk was left.

It shall be noted that due to the short term milk production behavior (as illustrated in FIG. 6), a calculated milk secretion rate based on a milking interval of more than a predetermined time (when the actual milk secretion rate drops, e.g. 12 at hours) may be disregarded when fitting the time dependent function to the calculated milk secretion rate. The upper arrow in FIG. 4 and the arrow in FIG. 3 identify such a case. The milking interval is more than 12 hours, and the calculated milk secretion rate value is much lower than expected.

Finally, the module for initiating initiates an action to be performed with respect to the specific cow or the specific udder quarter of the specific cow depending on the calculated expected milk yield. The expected milk yield may be used in various circumstances—it may be used by its own or it may be compared with other parameters, particularly with milk yielded during milking if such action is performed. Below, a non-exhaustive list of different possible actions is found.

The action to be performed with respect to a cow may be to give the cow permission to be milked. The action may be initiated provided that the calculated expected milk yield is larger than a predetermined milk yield, optionally combined with other milking permission parameters.

If milking of the specific udder quarter of the specific cow is performed, the milk yield as obtained during milking is recorded, and the action to be performed with respect to the cow may be to finish the milking of that udder quarter, possibly after a teat cup kick-off. Preferably, the action is initiated if the recorded milk yield is higher than D times the calculated expected milk yield, where D is a positive constant lower than 1.

Still further, the action to be performed with respect to a cow may be to indicate a drop in production. The action may be initiated if the recorded milk yield is lower than E times the calculated expected milk yield, where E is a positive constant lower than 1. The drop in production may e.g. indicate that the milking equipment is malfunctioning, that the cow is difficult to milk, or that the cow has an infection, is ill, or is not eating and drinking as she should.

Note that the respective actions shall typically only be initiated if the deviations are large enough not be considered to be within normal variations for the specific udder quarter or cow. Thus, the constants D and E may be related to the variation or standard deviation of recent calculated milk secretion rates.

It shall be noted that to fit the function F(t) to the calculated milk secretion rate with a certain accuracy, a certain number of milk secretion rates must have been recorded. Thus, the accuracy will not be especially good in the very beginning of a lactation when the milking of the cow has just started. Such limitation may be remedied in the following manners.

An expected milk secretion rate for a specific udder quarter of a specific cow at a time in the beginning of a lactation period LNᵢ₊₁ may be estimated based on a further time dependent function Fᵢ₊₁(t), wherein this further time dependent function Fᵢ₊₁(t) is based on a time dependent function Fᵢ(t) fitted to calculated milk secretion rates in a previous lactation period, preferably the last completed lactation period L_{N}. This assumes, however, that the milk yields and milking times in an earlier lactation period were really recorded.

The time dependent function Fᵢ₊₁(t) may further be based on the lactation number of the lactation period. Generally, cows have yearly accumulated milk yields (accumulated milk yields during each lactation period), which are low for young cows, higher for elder cows, and lower again for yet elder cows. Thus by knowing the lactation number and optionally the age of the cow, the expected milk secretion rate may be corrected by a factor close to 1—slightly smaller or slightly larger depending on whether the cow has reached her maximum yearly milk yield or not. A further correction factor/term may be introduced depending on when the cow becomes pregnant in the lactation period.

However, if the cow has her first lactation period or if no detailed prior knowledge of milk yields and milking times from earlier lactation periods is known, the above approach is not possible to use.

In this case, the expected milk secretion rate for a specific udder quarter of the cow may, in the beginning of a lactation period, be estimated based on a time dependent function F₃(t), where this function F₃(t) is based on a time dependent function F_{G}(t) fitted to calculated milk secretion rates for an udder quarter of another cow, for all udder quarters of another cow, or for a group of udder quarters from different cows. This other udder quarter(s) and cow(s) may be selected to be similar to the udder quarter/cow, for which the expected milk secretion rate shall be determined, e.g. same breed and similar age.

The time dependent function F₃(t) may additionally be based on any of milk production history, breed, lactation number, production level, health, physical condition, feed consumption, number of days in milk, number of days not pregnant, lactation persistency, season of last calving, rank in herd, milking frequency, and occurrence of milking problems of the cow with the udder quarter, for which the expected milk secretion rate shall be determined. Alternatively, or additionally, the time dependent function F₃(t) may be based on any of milk production history, production level, health, physical condition, occurrence of milking problems and position of the udder quarter, for which the expected milk secretion rate shall be determined.

The model of the present invention may in general take into account different information as obtained during operation, where the information may be related to the parameters listed above or to other. For instance, when determining an expected milk secretion rate for an udder quarter of a cow, any injuries or infections of the udder quarter of the cow occurring at a time before or following the last one of the recorded milkings, may be taken into account by employment of a correction factor or term.

It shall be appreciated by the person skilled in the art that the present invention may be implemented in virtually any kind of automated or semi-automated milking system, which has the capability of measuring milk yields on an udder quarter individual or animal individual basis.

1. A method for initiating an action to be performed with respect to a milking animal, characterized by the steps of:
recording a plurality of milk yields (MY1, MY2, . . . , MYN) as obtained during a plurality of milkings of an udder quarter or an udder of a milking animal;
recording the time (t1, t2, . . . , tN) of each of said plurality of milkings;
calculating milk secretion rates (MSR1, MSR2, . . . , MSRN) for said udder quarter or udder of said milking animal based on said recorded plurality of milk yields and times;
fitting a time dependent function (F(t)) to said calculated milk secretion rates, said time dependent function comprising one portion, which increases with time, and one portion, which decreases with time;
estimating an expected milk secretion rate (EMSRt) for said udder quarter or udder of said milking animal at a time (tN+1) following the last one of said recorded plurality of milkings based on said time dependent function (F(t));
determining an expected milk yield (EMYt) for said udder quarter or udder of said milking animal at said time (tN+1) based on said estimated expected milk secretion rate and, at said time, the time period (tN+1−tN) lapsed since last milking of said udder quarter or udder of said milking animal; and
initiating an action to be performed with respect to said milking animal depending on said determined expected milk yield.

2. The method of claim 1 wherein said time dependent function (F(t)) is fitted to said calculated milk secretion rates by a non-linear minimum quadratic method.

3. The method of claim 1 wherein, if a value of said calculated milk secretion rates deviates from said time dependent function (F(t)) with more than a predetermined amount, said value is deleted from said calculated milk secretion rates and said step of fitting said time dependent function (F(t)) to said calculated milk secretion rates is repeated.

4. The method of claim 1 wherein said plurality of recorded times are given as times since the beginning of a lactation period of said milking animal and said plurality of recorded times are all within said lactation period.

5. The method of claim 4 wherein said time dependent function (F(t)) increases with time for low time values to reach a maximum value and to then decrease with time.

6. The method of claim 1 wherein said time dependent function (F(t)) is given by a polynomial (F(t)=A+Bt+Ct2+ . . . ) of at least second order.

7. The method of claim 1 wherein said expected milk yield for said udder quarter or udder of said milking animal at said time is determined as said estimated expected milk secretion rate multiplied with said time period lapsed since last milking of said udder quarter or udder of said milking animal provided that said time period is within a predetermined range.

8. The method of claim 1 wherein said expected milk yield for said udder quarter or udder of said milking animal at said time is determined to be lower than said estimated expected milk secretion rate multiplied with said time period lapsed since last milking of said udder quarter or udder of said milking animal provided that said time period is longer than a predetermined period of time.

9. The method of claim 1 wherein said expected milk yield for said udder quarter or udder of said milking animal at said time is determined to be higher than said estimated expected milk secretion rate multiplied with said time period lapsed since last milking of said udder quarter or udder of said milking animal provided that the calculated milk secretion rate at the time of said last milking of said udder quarter or udder of said milking animal is considerably lower than said time dependent function (F(t)) at that time.

10. The method of claim 1 wherein
said action to be performed with respect to said milking animal is to give said milking animal permission to be milked; and
said action is initiated provided that said determined expected milk yield is larger than a predetermined milk yield.

11. The method of claim 1 wherein
the milk yield as obtained during milking of said udder quarter or udder of said milking animal at said time is recorded; and
said action to be performed with respect to said milking animal is to finish said milking of said udder quarter or udder of said milking animal, optionally after a teat cup kick-off; and
said action is initiated if said recorded milk yield is higher than D times said determined expected milk yield, where D is a positive constant not higher than 1.

12. The method of claim 1 wherein
the milk yield as obtained during milking of said udder quarter or udder of said milking animal at said time is recorded;
said action to be performed with respect to said milking animal is to indicate a drop in production; and
said action is initiated if said recorded milk yield is lower than E times said determined expected milk yield, where E is a positive constant lower than 1.

13. The method of claim 1 wherein
said times are all within a lactation period (LNi); and
an expected milk secretion rate for said udder quarter or udder of said milking animal at a time in the beginning of a following lactation period (LNi+1) is estimated based on a further time dependent function (F2(t)), where said further time dependent function (F2(t)) is based on said time dependent function (F(t)) fitted to said calculated milk secretion rates.

14. The method of claim 13 wherein said further time dependent function (F2(t)) is based on the lactation number of said following lactation period.

15. The method of claim 13 wherein said further time dependent function (F2(t)) is based on when said milking animal becomes pregnant in said following lactation period.

16. The method claim 1 wherein, in said step of estimating an expected milk secretion rate for said udder quarter or udder of said milking animal, any injuries or infections of said udder quarter or udder of said milking animal occurring at a time following the last one of said recorded plurality of milkings, are taken into account by employment of a correction term or factor.

17. The method of claim 1 wherein an expected milk secretion rate for an udder quarter or udder of another milking animal in the beginning of a lactation period is estimated based on a still further time dependent function (F3(t)), where said still further time dependent function (F3(t)) is based on said time dependent function (F(t)) fitted to said calculated milk secretion rates.

18. The method of claim 17 wherein said still further time dependent function (F3(t)) is based on any of milk production history, breed, lactation number, production level, health, physical condition, feed consumption, number of days in milk, number of days not pregnant, lactation persistency, season of last calving, rank in herd, milking frequency, and occurrence of milking problems of said another milking animal.

19. The method of claim 17 wherein said still further time dependent function (F3(t)) is based on any of milk production history, production level, health, physical condition, occurrence of milking problems and position of the udder quarter or udder of said another milking animal.

20. A computer program product loadable into the internal memory of a computer (35) of a milking station, comprising software code portions for carrying out the method as claimed in claim 1 when said product is run on said computer.

21. A milking station comprising a milking machine and a process and control device (35) adapted to carry out the method as claimed in claim 1.
